(19) United States
(12) Patent Application Publication
(10) Pub. No.: US 2025/0133093 A1
(43) Pub. Date: Apr. 24, 2025

(54) METHOD FOR ANALYZING ALERTS OF AN ORGANIZATION USING ALERT CLUSTERS AND CHAINS OF EVENTS THAT TRIGGER THE ALERTS

(71) Applicant: VMware, Inc., Palo Alto, CA (US)

(72) Inventors: Jonathan James OLIVER, Kew (AU); Raghav BATTA, Livermore, CA (US); Ioana Maria ANGHEL, Sunnyvale, CA (US)

(21) Appl. No.: 18/490,643

(22) Filed: Oct. 19, 2023

(51) Int. Cl. H04L 9/40; G06N 5/022

(52) U.S. Cl. CPC H04L 63/1416; G06N 5/022; H04L 63/1425

(57) ABSTRACT

A computer system comprises a machine-learning (ML) system at which alerts are received from endpoints, wherein the ML system is configured to: upon receiving a first alert and a second alert, apply an ML model to the first and second alerts; based at least in part on the first alert being determined to belong to a first cluster of the ML system, classify the first alert into one of a plurality of alert groups, wherein alerts classified into a first alert group of the alert groups are assigned a higher priority for security risk evaluation than alerts classified into a second alert group of the alert groups; and based on the second alert being determined to not belong to any cluster of the ML system, analyze a chain of events that triggered the second alert to determine whether there is suspicious activity associated with the second alert.

### BACKGROUND

Security operations centers (SOCs) provide services for monitoring computer systems of organizations to detect threats. At SOCs, SOC analysts use a various of security analytics tools to evaluate security alerts. Such tools include security information and event management (SIEM) software, which includes components for automatically evaluating alerts and also components that enable manual evaluation by SOC analysts. Such tools also include correlation engines, which automatically evaluate alerts. The alerts are contextual and identify values of various attributes, such values being used for determining whether the alerts were generated in response to malicious activity or harmless activity.

The number of alerts generated by security systems is often too large to effectively monitor the computer systems. For example, the number of alerts may far outweigh the number of alerts that a team of SOC analysts can triage in a timely manner. As a result, the SOC analysts may identify malicious activity too late for remediation measures to be effective. Indeed, SOC analysts may not even have a chance to review malicious alerts before related breaches are already well underway and detected through other methods. Additionally, in the case of automatic evaluators such as correlation engines, the number of alerts may be too large for the evaluators to determine malicious activity accurately.

In some cases, security systems have adapted by increasing the precision of the rules used for generating alerts. This decreases the number of alerts that are generated because not as many activities of the computer system match the rules and trigger alerts. Such increases in precision also result in less false positives, i.e., less cases in which an alert is triggered by harmless activity. However, such increases in precision typically reduce the capabilities of SOCs to detect malicious activity as attackers often take advantage of such changes. For example, attackers frequently create new malware for which the security systems have not yet incorporated precise rules for detecting. As another example, instead of using malware at all, attackers often break into computer systems and use administrative tools therein such as PowerShell® to encrypt data and blackmail and extort organizations. Such attacks, known as living-off-the-land (LOTL) attacks, are difficult to detect with precise rules.

In other cases, instead of incorporating more precise rules, security systems have leveraged “threat scores” that are associated with the rules, e.g., values between 1 and 10. Such scores have typically been determined by security analysts who write the rules. The scores have been used to prioritize alerts, alerts that are generated in response to rules with high threat scores being evaluated before alerts that are generated in response to rules with low threat scores. However, this manner of applying threat scores has been notoriously inconsistent at prioritizing alerts. Indeed, activity that is expected and likely harmless for a computer system of one organization may be unusual and likely malicious for a computer system of another organization.

In sum, merely reducing the coverage of alerts with highly precise rules leaves computer systems vulnerable to malicious activity. Meanwhile, traditional techniques for prioritizing alerts such as applying predetermined threat scores have proven to be ineffective for intelligently prioritizing alerts for evaluation by security analytics platforms. A method and computer system are needed for more effectively processing large numbers of alerts for evaluation such that malicious activity may be identified and then remediated more quickly.

### SUMMARY

One or more embodiments provide a computer system comprising a plurality of endpoints at which security agents generate alerts. The computer system further includes a machine-learning (ML) system at which alerts are received from the endpoints. The ML system is configured to execute on a processor of a hardware platform to: upon receiving a first alert and a second alert, apply an ML model to the first and second alerts; based at least in part on the first alert being determined based on the applied ML model to belong to a first cluster of the ML system, classify the first alert into one of a plurality of alert groups, wherein alerts classified into a first alert group of the alert groups are assigned a higher priority for security risk evaluation than alerts classified into a second alert group of the alert groups; and based on the second alert being determined based on the applied ML model to not belong to any cluster of the ML system, analyze a chain of events that triggered the second alert to determine whether there is suspicious activity associated with the second alert.

Further embodiments include a method of processing alerts as the above computer system is configured to perform and a non-transitory computer-readable storage medium comprising instructions that cause a computer system to carry out such a method.

### BRIEF DESCRIPTION OF THE DRAWINGS

FIG. 1 is a block diagram of a virtualized computer system in which embodiments may be implemented.

FIG. 2 is a block diagram illustrating components of an ML system of the virtualized computer system, the ML system being configured to perform embodiments.

FIG. 3 illustrates an example of a cluster profile that specifies expected value constraints for attributes of alerts that belong to an associated cluster of the ML system.

FIG. 4A illustrates an example of a provenance graph of the ML system that includes a chain of events that triggered an alert.

FIG. 4B illustrates an example of an event frequency database of the ML system that includes frequencies at which various events have been observed for an organization.

FIG. 5 is a flow diagram of a method performed by the ML system to configure rule-based and graph-based ML platforms, according to embodiments.

FIG. 6 is a flow diagram of a method performed by the ML system to process an alert according to the rule-based ML platform, according to embodiments.

FIG. 7 is a flow diagram of a method performed by the ML system to process an alert according to the graph-based ML platform, according to embodiments.

FIG. 8 is a block diagram illustrating components of the ML system, the ML system being configured to perform alternative embodiments.

### DETAILED DESCRIPTION

Techniques for processing security alerts for evaluation are described. Alerts are generated at endpoints of a customer environment. Some of those alerts are generated in response to malicious activity and are referred to herein as “malicious alerts.” Other alerts are generated in response to harmless activity and are referred to herein as “harmless alerts.” However, before those alerts are evaluated at a security analytics platform, the nature of the alerts is unknown.

According to embodiments, two ML platforms are configured based on alerts received from the endpoints of the customer environment during a training period. A first ML platform, referred to herein as a “rule-based ML platform,” includes an ML model such as a clustering system or an artificial neural network (ANN). The ML model is trained to divide the alerts into a plurality of clusters. A second ML platform, referred to herein as a “graph-based ML platform,” analyzes chains of events that trigger alerts to determine whether there is suspicious activity in the triggering events.

In the rule-based ML platform, some of the clusters, referred to herein as “high-priority clusters,” include alerts that are likely malicious, e.g., because they were triggered by software tools that are known for being typically used for malicious activity. Other clusters, referred to herein as “gray clusters,” include alerts that are suspicious even if not likely malicious. For example, an alert triggered by downloading an attachment to an email may be assigned to a gray cluster because even though downloading such an attachment is usually harmless, it is also commonly malicious. Other clusters, referred to herein as “regular clusters,” include alerts that are not suspicious on their face. For each regular cluster, the rule-based ML platform creates a profile that includes attributes and value constraints observed for all the alerts of the cluster.

Later, during an operational period, each time a new alert is received by the ML system from the customer environment, the alert is first processed by the rule-based ML platform. The rule-based ML platform performs clustering on the new alert, e.g., assignment-based or probabilistic clustering. Based on the clustering, the rule-based ML platform either classifies the priority of the new alert, or the rule-based ML platform passes the alert on to the graph-based ML platform. For example, the rule-based ML platform may add the alert to a high-priority alert queue if the alert belongs to a high-priority cluster or if the alert belongs to a regular cluster for which the alert does not match expected value constraints. As another example, the rule-based ML platform may add the alert to a gray alert queue if the alert belongs to a gray cluster. As another example, the rule-based ML platform may add the alert to a low-priority alert queue if the alert belongs to a regular cluster for which the alert matches expected value constraints.

As mentioned above, in certain cases, instead of classifying the new alert, the rule-based ML platform passes the alert to the graph-based ML platform for analysis of a chain of events that triggered the alert. In particular, the graph-based ML platform constructs a provenance graph from the chain of events. If the provenance graph includes activity that has been predetermined to be suspicious such as downloading data from a website with a negative reputation, then the graph-based ML platform stores the new alert in the high-priority or gray alert queue. Otherwise, the graph-based ML platform analyzes an “event frequency database” to determine how prevalent events from the chain of events are for the organization from which the new alert was received. The graph-based ML platform then stores the new alert in a queue based on the prevalence of events within the chain of events, less prevalent events being more suspicious than more prevalent events.

Embodiments are able to automatically classify a large number of alerts for prioritizing evaluations thereof. Security agents of the customer environment may thus generate a large number of alerts covering a wide range of malicious activity. Furthermore, both ML platforms are configured based on alerts of a particular organization observed during the training period. The cluster profiles of the rule-based ML platform and the event frequency database of the graph-based ML platform are customized to the expected behavior of a particular organization. Accordingly, both ML platforms consistently prioritize alerts that are likely malicious for the organization over alerts that are likely harmless for the organization.

Additionally, the rule-based and graph-based ML platforms offer distinct advantages that are leveraged when used in combination. The rule-based ML platform is highly scalable, i.e., it may process large numbers of alerts relatively quickly. Furthermore, the cluster profiles of regular clusters of the rule-based ML platform include value constraints for several attributes. Accordingly, during the operational period, embodiments are able to detect even slight deviations between the activity that generated new alerts and expected activity of the customer environment. Furthermore, having value constraints for such a large number of attributes constrains the activities of potential attackers whose malicious behaviors may be easily detected by the rule-based ML platform when the behaviors do not comply with every value constraint of corresponding cluster profiles.

The graph-based ML platform is not as scalable as the rule-based ML platform, i.e., it would not be able to process a large number of alerts as quickly as the rule-based ML platform. Indeed, building provenance graphs for every alert would be very expensive and slow. However, for a subset of alerts, the graph-based ML platform classifies the alerts more accurately than the rule-based ML platform. Such subset includes certain alerts that are triggered by behavior that was not observed during the training period but that is not otherwise suspicious. For example, a developer of the organization downloading a new Python® library from a trustworthy source may trigger an alert that does not belong to any of the clusters of the rule-based ML platform.

The rule-based ML platform may consider such an alert to be suspicious simply because of the alert being far from any of the clusters. However, the graph-based ML platform correctly identifies based on the chain of events triggering the alert that none of the events are suspicious. The alert may thus be correctly given low priority for evaluation by SOC analysts who may focus on other alerts that are more likely malicious. These and further aspects of the invention are discussed below with respect to the drawings.

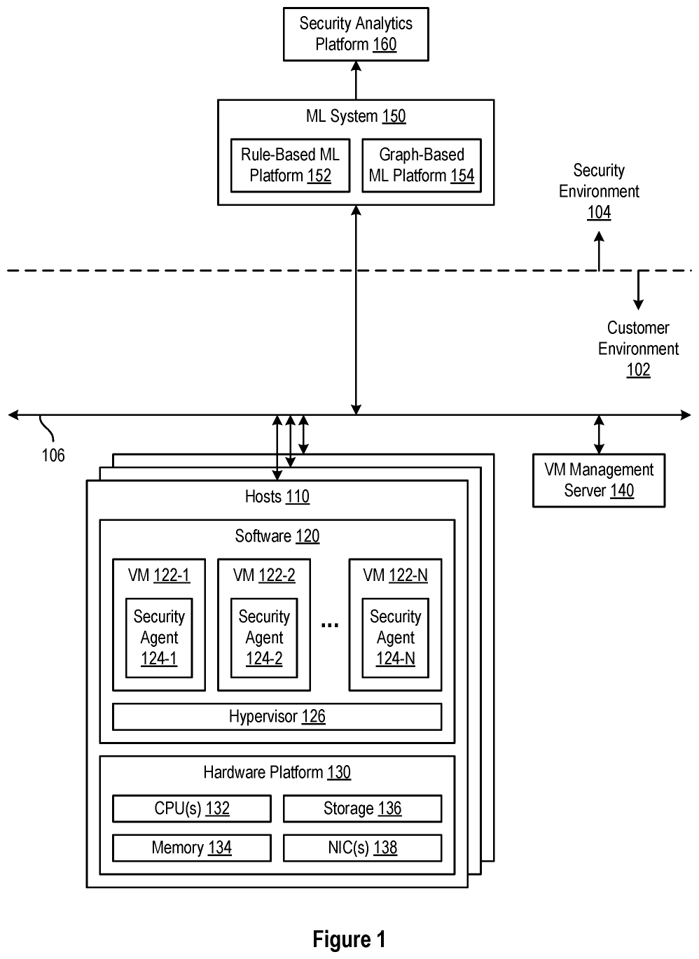

FIG. 1 is a block diagram of a virtualized computer system in which embodiments may be implemented. The virtualized computer system includes a customer environment 102 and an external security environment 104. As used herein, a “customer” is an organization that has subscribed to security services offered through an ML system 150 of security environment 104. A “customer environment” is the customer's own information technology (IT) environment (commonly referred to as “on-premise”), a private cloud managed by the customer, a public cloud managed for the customer by another organization, or any combination of these. Although security environment 104 is illustrated as external to customer environment 102, any components of security environment 104 may instead be implemented within customer environment 102.

Customer environment 102 includes a plurality of host computers 110, referred to herein simply as “hosts,” and a virtual machine (VM) management server 140. Each of hosts 110 is constructed on a hardware platform 130 such as an x86 architecture platform. Hardware platform 130 includes conventional components of a computing device, such as one or more central processing units (CPUs) 132, memory 134 such as random-access memory (RAM), local storage 136 such as one or more magnetic drives or solid-state drives (SSDs), and one or more network interface cards (NICs) 138. NICs 138 enable hosts 110 to communicate with each other and with other devices over a network 106 such as a local area network (LAN).

Hardware platform 130 of each of hosts 110 supports software 120. Software 120 includes a hypervisor 126, which is a virtualization software layer. Hypervisor 126 supports a VM execution space within which VMs 122 are concurrently instantiated and executed. One example of hypervisor 126 is a VMware ESX® hypervisor, available from VMware, Inc. VMs 122 include respective security agents 124, which generate alerts in response to suspicious activity. Although the disclosure is described with reference to VMs as endpoints of customer environment 102, the teachings herein also apply to nonvirtualized computers and to other types of virtual computing instances such as containers, Docker® containers, data compute nodes, and isolated user space instances for which behavior is monitored to discover malicious activities. Furthermore, although FIG. 1 illustrates VMs 122 and security agents 124 in software 120, the teachings herein also apply to security agents 124 implemented in firmware for hardware platform 130.

VM management server 140 logically groups hosts 110 into a cluster to perform cluster-level tasks such as provisioning and managing VMs 122 and migrating VMs 122 from one of hosts 110 to another. VM management server 140 communicates with hosts 110 via a management network (not shown) provisioned from network 106. VM management server 140 may be, e.g., one of hosts 110 or one of VMs 122. One example of VM management server 140 is VMware vCenter Server,® available from VMware, Inc.

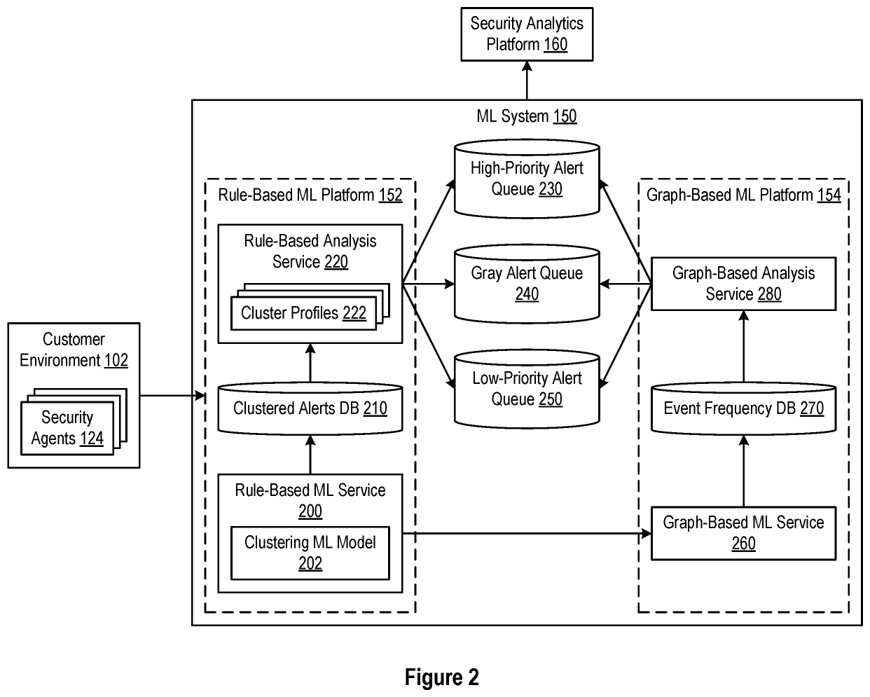

ML system 150 provides security services to VMs 122. ML system 150 communicates with VMs 122 over a public network (not shown), e.g., the Internet, to obtain alerts generated by security agents 124. Alternatively, if implemented within customer environment 102, ML system 150 communicates with VMs 122 over one or more private networks such as network 106. ML system 150 includes a rule-based ML platform 152 and a graph-based ML platform 154, which are discussed further below in conjunction with FIG. 2. The ML platforms of ML system 150 run in one or more VMs or containers and are deployed on hardware infrastructure (not shown).

The hardware infrastructure supporting ML system 150 includes the conventional components of a computing device discussed above with respect to hardware platform 130. CPU(s) of the hardware infrastructure are configured to execute instructions such as executable instructions that perform one or more operations described herein, which may be stored in memory of the hardware infrastructure. For some of the alerts received from VMs 122, ML system 150 transmits the alerts to a security analytics platform 160 for evaluation. For example, security analytics platform 160 may be an SOC at which SOC analysts use various security analytics tools to evaluate alerts such as SIEM software or correlation engines.

FIG. 2 is a block diagram illustrating components of ML system 150, which are configured to perform embodiments. Security agents 124 of customer environment 102 generate alerts based on suspicious activities in respective VMs 122 and transmit those alerts to ML system 150, e.g., over the Internet. During a training period of ML system 150, rule-based ML platform 152 and graph-based ML platform 154 analyze alerts generated at customer environment 102 during normal activity thereof.

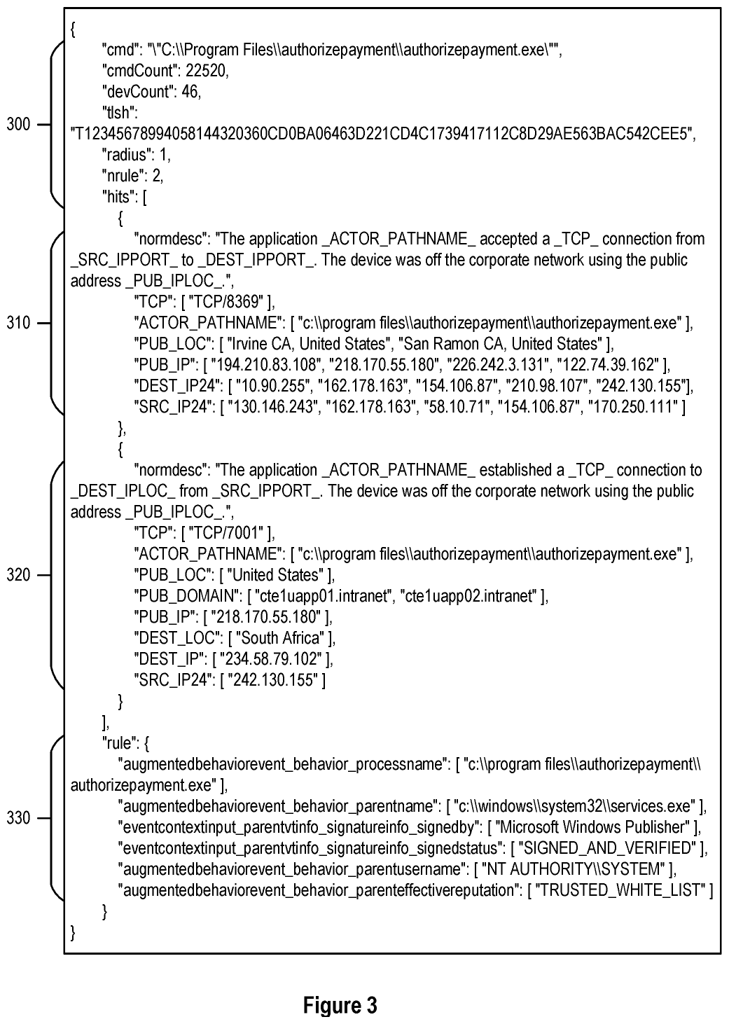

For rule-based ML platform 152, the training period involves a rule-based ML service 200 training a clustering ML model 202 such as such as a clustering system or an ANN to divide the alerts into clusters. Rule-based ML service 200 then stores the clusters of alerts in a clustered alerts database (DB) 210. Clustering ML model 202 clusters the alerts based on at least one attribute of the alerts such as initiators of the activities that triggered the alerts. As a next portion of the training period, for each of the regular clusters (i.e., for clusters that are not labeled as high-priority or gray clusters), a rule-based analysis service 220 aggregates values of attributes of all the alerts of the cluster. Rule-based analysis service 220 uses the aggregate values for each of the regular clusters to generate cluster profiles 222. Each of cluster profiles 222 is referred to herein simply as cluster profile 222, an example of which is discussed below in conjunction with FIG. 3.

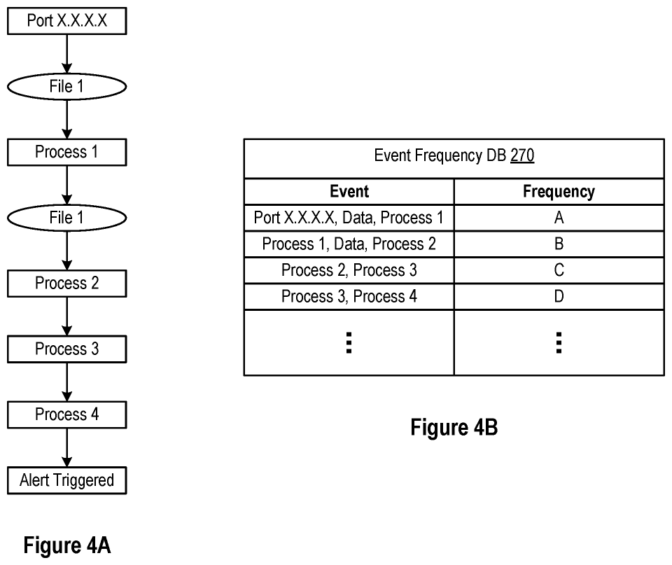

For graph-based ML platform 154, the training period involves a graph-based ML service 260 aggregating events associated with the alerts. Those events may include, e.g., one process calling another process, one process receiving data over a socket, etc. Graph-based ML service 260 stores these events in an event frequency database 270 along with overall frequencies for those events occurring among the alerts during the training period. An example of event frequency database 270 is discussed below in conjunction with FIG. 4B.

During an operational period of ML system 150 (after the training period), new alerts are continually received by ML system 150 from security agents 124 as VMs 122 continue to execute. A new alert is first received at rule-based ML platform 152. Rule-based ML service 200 first applies clustering (assignment-based or probabilistic) on the new alert. Then, if the new alert belongs to a cluster (or partially to multiple clusters in the case of probabilistic clustering), rule-based analysis service 220 attempts to classify the alert. For example, if a new alert is likely malicious, the new alert is classified into a high-priority group and stored in a high-priority alert queue 230. If the new alert is suspicious but not as likely to be malicious as alerts in the high-priority group, the new alert is classified into a gray group and stored in a gray alert queue 240. If the new alert is likely harmless, the new alert is classified into a low-priority group and stored in a low-priority alert queue 250.

On the other hand, rule-based ML platform 152 may determine to pass the alert to graph-based ML platform 154. For example, rule-based ML service 200 may determine that the alert does not belong to any of the clusters of clustered alerts database 210. In such cases, graph-based ML platform 154 classifies the new alert instead of rule-based ML platform 152. Specifically, graph-based ML service 260 builds a provenance graph that includes a chain of events that triggered the new alert. An example of a provenance graph is discussed below in conjunction with FIG. 4A. A graph-based analysis service 280 then determines how to classify the new alert based on causal links in the built provenance graph and on entries of event frequency database 270.

ML system 150 eventually dequeues alerts in high-priority alert queue 230 and gray alert queue 240 and transmits them to security analytics platform 160 for evaluation. Alerts in high-priority alert queue 230 are prioritized over those of gray alert queue 240. Alerts in low-priority alert queue 250 may later be transmitted to security analytics platform 160 on demand, e.g., upon malicious activity being detected and there potentially being evidence of the activity in alerts of the low-priority group. Although FIG. 2 illustrates three alert queues, embodiments may vary the number of alert queues used. For example, there may simply be two alert queues, one for high-priority alerts and another for low-priority alerts. There may also be more than three alert queues, thus creating more than three tiers of priority.

FIG. 3 illustrates an example of cluster profile 222, represented in JavaScript Object Notation (JSON) format. Lines 300 of cluster profile 222 include attributes of the associated regular cluster. As indicated by the value of the “cmd” attribute of lines 300, every alert of the cluster executed a command that was similar (if not identical) to the following command: “C: \Program Files\authorizepayment\authorizepayment.exe.” As indicated by the value of the “cmdCount” attribute of lines 300, the size of the cluster is 22,520, i.e., there are 22,520 alerts in the cluster.

The value of the “tlsh” (trend locality sensitive hash) attribute of lines 300 represents the center of the cluster, the tlsh being a hash of the values of any attributes that were used for clustering the alerts. In the example of FIG. 3, the “cmd” attribute was used for clustering the alerts, and the value of the “tlsh” attribute is thus a hash of the value of the “cmd” attribute. The “tlsh” value is used to determine whether a new alert belongs to a particular cluster. Specifically, a command line indicated by the new alert is hashed and compared to the value of the “tlsh” attribute. If the distance is within a threshold indicated by the value of the “radius” attribute, then the new alert belongs to the cluster. It should be noted that applying TLSHs is merely one method of clustering alerts. Other known methods in the art may alternatively be used.

Cluster profile 222 includes a number “nrule” of rules associated with the cluster. The rules associated with a cluster include all the rules of customer environment 102 that triggered alerts of the cluster, such rules being used by security agents 124 for identifying suspicious (and potentially malicious) activity. Cluster profile 222 illustrated by FIG. 3 includes two such rules, one represented in lines 310 and another represented in lines 320. However, the number of rules that may trigger alerts of a cluster may be only one or may be much greater.

The first rule, represented in lines 310, is triggered by one of VMs 122 accepting an inbound transmission control protocol (TCP) connection. Lines 310 include a plurality of attributes of alerts that triggered the first rule, including “TCP,” “ACTOR_PATHNAME,” etc. Every alert of the cluster that triggered the first rule during the training period had values matching one of those indicated by the expected value constraints of lines 310. For example, each such alert had a value “TCP/8369” for the “TCP” attribute, and each alert had either a value “Irvine CA, United States” or a value “San Ramon CA, United States” for a “PUB LOC” attribute. Additionally, some of the expected value constraints of lines 310 are derived. For example, alerts may have included destination IP addresses such as 10.90.255.1, 10.90.255.2, etc. Instead of including each such IP address in lines 310, ML system 150 derives the net block 10.90.255 and determines that any IP addresses from that net block are expected destination IP addresses for the organization. In lines 310, ML system 150 thus adds the value “10.90.255” as a value constraint for a “DEST_IP24” attribute.

The second rule, represented in lines 320, is triggered by one of VMs 122 establishing an outbound TCP connection. Lines 320 include a plurality of attributes of alerts that triggered the second rule, including “TCP,” “ACTOR_PATHNAME,” etc. Every alert of the cluster that triggered the second rule during the training period had values matching one of those indicated by the expected value constraints of lines 320. For example, each such alert had a source IP address within the net block “242.130.155,” as indicated by the derived value of an “SRC IP24” attribute of lines 320.

Lines 330 include additional attributes common to all the alerts of the cluster, including those that were triggered by the first rule and those that were triggered by the second rule. Those additional attributes include, e.g., “augmentedbehaviorevent_behavior_processname.”

For example, every alert of the cluster had a value “c: \program files\authorizepayment\authorizepayment.exe” for that attribute.

It should be noted that FIG. 3 only illustrates certain types of expected value constraints such as expected values, lists of expected values, and expected IP ranges. Other types of expected value constraints may also be added to cluster profiles according to embodiments. For example, regular expressions that express patterns may be used as expected value constraints for various attributes. As another example, numerical ranges such as “>2” may be used as expected value constraints for various attributes.

When a new alert is determined to belong to the cluster associated with the illustrated cluster profile, values of attributes for the new alert are compared to value constraints of the cluster profile to determine how to classify the new alert. For example, if the new alert was triggered by the first rule, attributes for the new alert are compared to every attribute of lines 310 and 330. Otherwise, if the new alert was triggered by the second rule, attributes for the new alert are compared to every attribute of lines 320 and 330. Any deviations may result in classification into one of the high-priority and gray groups, while there being no deviations results in classification into the low-priority group.

It should be noted that other applications of cluster profile 222 are envisioned. For example, if 22,520 (the value for “cmdCount” in lines 300) is less than a predetermined threshold, then the cluster may be considered to be statistically insignificant. In such case, when a new alert is determined to belong to the cluster, the new alert may automatically be classified into one of the high-priority and gray groups regardless of the values of attributes for the new alert. This is because alerts that were similar to the new alert were relatively rare during training.

FIG. 4A illustrates an example of a provenance graph that includes a chain of events that triggered an alert, each of the events being a causal link in the provenance graph. As a first event of the provenance graph, a “Process 1” downloaded a “File 1” from a “Port X.X.X.X” of one of VMs 122. As a second event, Process 1 transmitted File 1 to a “Process 2.” As third and fourth events, Process 2 triggered a “Process 3,” and Process 3 triggered a “Process 4.” Execution of Process 4 triggered one of security agents 124 generating an alert.

When graph-based analysis service 280 analyzes the illustrated provenance graph, it may determine that one of the events involves a predetermined suspicious activity. For example, port X.X.X.X may be associated with an email application, so the first event is Process 1 downloading File 1 from an attachment to an email. It may be predetermined by the organization or by ML system 150 that downloading data from an attachment to an email is suspicious, in which case graph-based analysis service 280 classifies the alert into one of the high-priority and gray groups. If there is no predetermined suspicious activity implicated by the provenance graph, graph-based analysis service 280 analyzes the events of the provenance graph based on event frequency database 270, as discussed further below.

It should be noted that the provenance graphs used by embodiments capture chains of events that may span multiple endpoints. In the example of FIG. 4A, Port X.X.X.X may be a port of one VM, e.g., VM 122-1. However, Process 2 may run on a different VM, e.g., VM 122-2. The alert triggered by the illustrated chain of events may be generated by security agent 124-2 of VM 122-2 even though some of the events of the provenance graph were observed in a different VM by a different security agent.

FIG. 4B illustrates an example of event frequency 270. In the example of FIG. 4B, event frequency database 270 includes each of the events from the provenance graph of FIG. 4A. Event frequency database 270 also includes frequencies at which each of the events were observed during the training period of ML system 150. For example, frequency values may simply be count values of how many times corresponding events were observed.

A first entry of event frequency database 270 indicates that during training, Process 1 downloaded data from Port X.X.X.X with a frequency of “A,” e.g., A times. A second entry of event frequency database 270 indicates that Process 1 provided data to Process 2 with a frequency of “B.” Third and fourth entries of event frequency database 270 indicate that during training, Process 2 triggered Process 3 and Process 3 triggered Process 4 with frequencies of “C” and “D,” respectively. The greater a frequency value is, the less suspicious the associated event is, and the less a frequency value is, the more suspicious the associated event is.

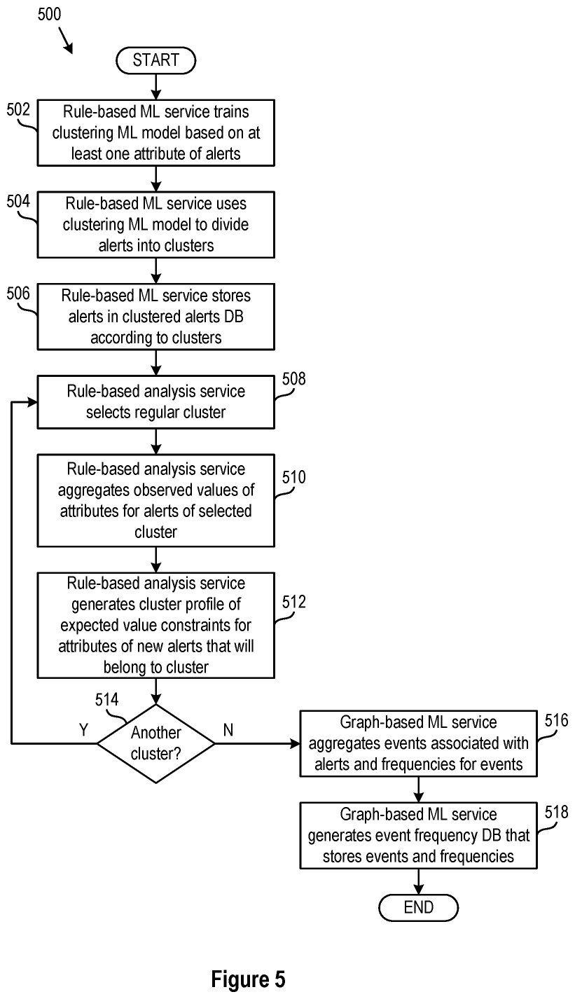

FIG. 5 is a flow diagram of a method 500 performed by ML system 150 to configure rule-based ML platform 152 and graph-based ML platform 154, according to embodiments. Method 500 is performed during the training period. At step 502, rule-based ML service 200 trains clustering ML model 202 based on at least one attribute of alerts received during the training period. For example, the at least one attribute may comprise initiators of activities that triggered the alerts. Such initiators may be, e.g., command lines entered into administrative tools such as PowerShell,® creations of processes, or scheduling of tasks.

At step 504, rule-based ML service 200 uses clustering ML model 202 to divide the alerts into clusters. At step 506, rule-based ML service 200 stores the alerts in clustered alerts database 210. Rule-based ML service 200 may mark some of such clusters as high-priority clusters or gray clusters based on predefined criteria such as usage of suspicious tools or downloading of email attachments. At step 508, rule-based analysis service 220 selects a regular cluster (a cluster not marked as high-priority or gray) from clustered alerts database 210. At step 510, rule-based analysis service 220 aggregates observed values of attributes for all the alerts of the cluster. At step 512, rule-based analysis service 220 generates cluster profile 222 from the aggregated observed values. Cluster profile 222 includes the observed values as expected value constraints for the attributes of new alerts that will later be determined to belong to the cluster during the operational period.

At step 514, if there is another regular cluster that has not yet been selected, method 500 returns to step 508, and rule-based analysis service 220 selects another regular cluster. Otherwise, at step 514, if one of cluster profiles 222 has been created for every regular cluster, method 500 moves to step 516. At step 516, graph-based ML service 260 aggregates events associated with the alerts received during the training period along with frequencies for the events. At step 518, graph-based ML service 260 generates event frequency database 270 to store the corresponding events and frequencies. After step 518, method 500 ends.

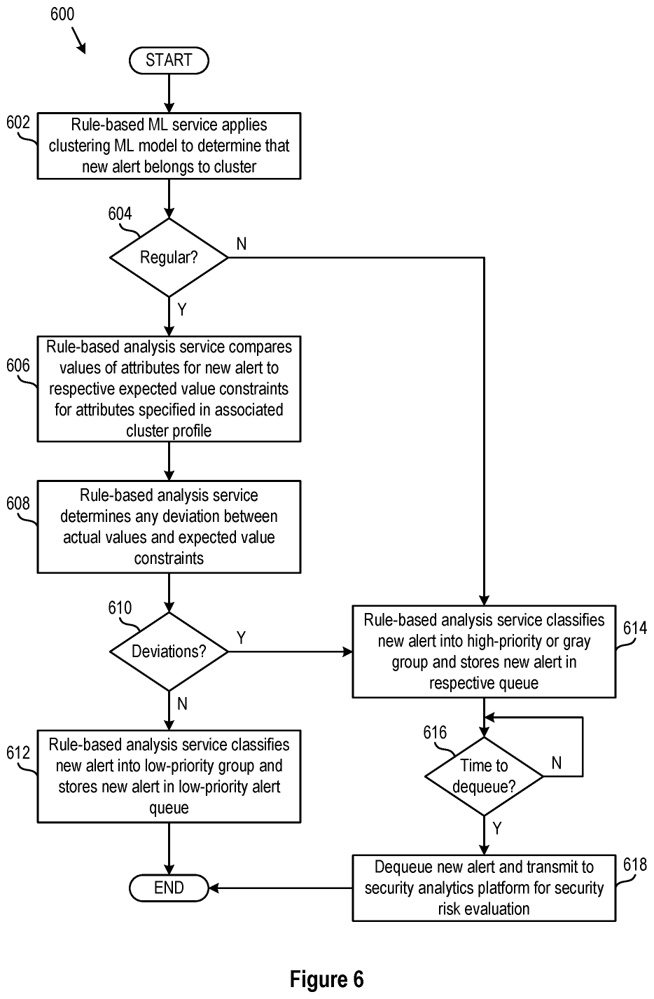

FIG. 6 is a flow diagram of a method 600 performed by ML system 150 to process an alert according to rule-based ML platform 152, according to embodiments. Method 600 is performed during the operational period of ML system 150 after rule-based ML platform 152 receives a new alert generated by one of security agents 124. Method 600 is discussed with respect to assignment-based clustering, but probabilistic clustering is also possible. At step 602, rule-based ML service 200 applies clustering ML model 202 to determine that the new alert belongs to a cluster of clustered alerts database 210. For example, in the case of cluster profile 222 of FIG. 3, rule-based ML service 200 hashes a value of the “cmd” attribute for the new alert and determines that the hash is within a threshold distance from a value of the “tlsh” attribute of the cluster.

At step 604, if the cluster is marked in clustered alerts database 210 as a high-priority or gray cluster, method 600 moves to step 614. Otherwise, if the cluster is a regular cluster, method 600 moves to step 606. At step 606, rule-based analysis service 220 compares values of attributes for the new alert (actual values) to respective value constraints for attributes specified in cluster profile 222 (expected value constraints). Some of the attributes only correspond to a particular rule that triggered the alert. Other attributes correspond to all the alerts of cluster profile 222. At step 608, rule-based analysis service 220 determines any deviation between the actual values and the expected value constraints.

At step 610, if there are no deviations, method 600 moves to step 612. At step 612, rule-based analysis service 220 classifies the new alert into the low-priority group and stores the new alert in low-priority alert queue 250. After step 612, method 600 ends. Returning to step 610, if there is at least one deviation between an actual value and an expected value constraint, method 600 moves to step 614.

At step 614, rule-based analysis service 220 classifies the new alert into either the high-priority or gray group and stores the new alert in the respective queue, i.e., in high-priority alert queue 230 for the high-priority group or in gray alert queue 240 for the gray group. If the alert belongs to a high-priority or gray cluster, rule-based analysis service 220 classifies the alert into the high-priority or gray group, respectively. Otherwise, how ML system 150 distinguishes between the high-priority and gray group is predetermined by an administrator of ML system 150. In any case, alerts in high-priority queue 230 are prioritized for evaluation by security analytics platform 160 over alerts in gray alert queue 240.

At step 616, ML system 150 determines whether it is time to dequeue the new alert. ML system 150 makes this determination based on the new alert's priority relative to other alerts. Alerts are dequeued more quickly from high-priority alert queue 230 than from gray alert queue 240. If it is not time to dequeue the new alert, method 600 remains at step 616, and ML system 150 waits until it is time to dequeue the new alert. If it is time to dequeue the new alert, method 600 moves to step 618.

At step 618, ML system 150 dequeues the new alert and transmits it to security analytics platform 160 for security risk evaluation. At security analytics platform 160, the new alert is evaluated for malicious activity of the computer system, i.e., it is determined whether the new alert is a malicious alert or a harmless alert. If the new alert is a malicious alert, security analytics platform 160 quickly identifies the associated malicious activity and remediates customer environment 102 accordingly.

After step 618, method 600 ends. Although method 600 is discussed with respect to assignment-based clustering, rule-based ML platform 152 may instead utilize probabilistic clustering. In the case of probabilistic clustering, rule-based ML service 200 identifies a plurality of clusters that the alert may belong to and probabilities of membership to the different clusters. Rule-based analysis service 220 then applies any known technique for analyzing variances between actual values of the alert and expected value constraints of the different clusters along with the probabilities of belonging to the clusters. Based on such analysis, rule-based analysis service 220 determines how suspicious the alert is and resultingly how to classify the alert and which queue of ML system 150 to store the alert in (or whether to pass the alert to graph-based ML platform 154).

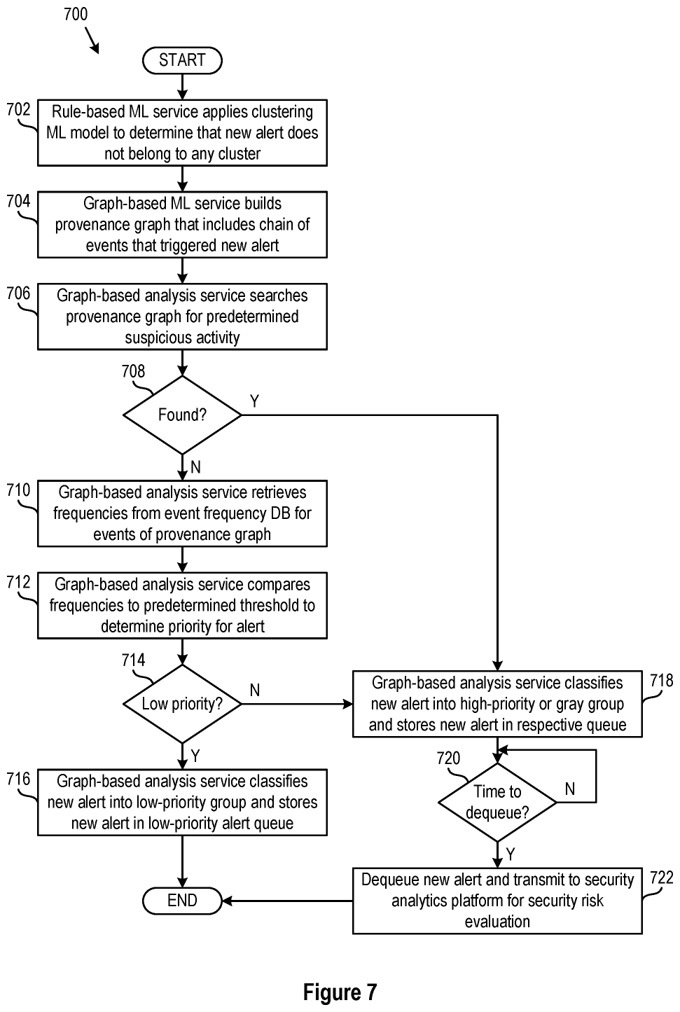

FIG. 7 is a flow diagram of a method 700 performed by ML system 150 to process an alert according to graph-based ML platform 154, according to embodiments. Method 700 is performed during the operational period of ML system 150 after rule-based ML platform 152 receives a new alert generated by one of security agents 124. At step 702, rule-based ML service 200 applies clustering ML model 202 to determine that the new alert does not belong to any of the clusters of clustered alerts database 210. For example, rule-based ML service 200 may hash a value of an attribute for the new alert and determine that the hash is not within a threshold distance from a value of a “tlsh” attribute of any of the clusters of clustered alerts database 210.

At step 704, graph-based ML service 260 builds a provenance graph that includes a chain of events that triggered the new alert. For example, graph-based ML service 260 may determine the chain of events based on metadata included with the new alert or any derived event properties that indicate causal relationships between events that triggered the alert. At step 706, graph-based analysis service 280 searches the provenance graph for predetermined suspicious activity such as downloading data from a website that has a negative reputation. At step 708, if graph-based analysis service 280 finds predetermined suspicious activity, method 700 moves to step 718.

Otherwise, if graph-based analysis service 280 does not find predetermined suspicious activity, method 700 moves to step 710. At step 710, graph-based analysis service 280 retrieves frequencies from event frequency database 270 for events of the provenance graph, the events corresponding with casual links in the provenance graph. At step 712, graph-based analysis service 280 compares the frequencies to a predetermined threshold to determine a priority for the new alert. For example, graph-based analysis service 280 may compare individual frequencies to the threshold or frequencies of a plurality of the events collectively to the threshold.

At step 714, graph-based analysis service 280 determines how to classify the priority of the alert based on the comparison(s). As one example, if each of the individual frequencies are greater than the threshold (or the frequency of the plurality of the events is collectively greater than the threshold depending on what is checked), method 700 moves to step 716. At step 716, graph-based analysis service 280 classifies the new alert into the low-priority group and stores the new alert in low-priority alert queue 250. After step 716, method 700 ends.

Returning to step 714, continuing the example, if one of the individual frequencies is less than the threshold (or the frequency of the plurality of the events is collectively less than the threshold depending on what is checked), method 700 moves to step 718. At step 718, graph-based analysis service 280 classifies the new alert into either the high-priority or gray group and stores the new alert in the respective queue, i.e., in high-priority alert queue 230 for the high-priority group or in gray alert queue 240 for the gray group. As mentioned previously, alerts classified as high-priority are prioritized for evaluation over alerts classified as gray priority.

At step 720, ML system 150 determines whether it is time to dequeue the new alert. As mentioned previously, ML system 150 makes this determination based on the new alert's priority relative to other alerts. Alerts are dequeued more quickly from high-priority alert queue 230 than from gray alert queue 240. If it is not time to dequeue the new alert, method 700 remains at step 720, and ML system 150 waits until is time to dequeue the new alert. If it is time to dequeue the new alert, method 700 moves to step 722.

At step 722, ML system 150 dequeues the new alert and transmits it to security analytics platform 160 for security risk evaluation. At security analytics platform 160, the new alert is evaluated for malicious activity of the computer system, i.e., it is determined whether the new alert is a malicious alert or a harmless alert. If the new alert is a malicious alert, security analytics platform 160 quickly identifies the associated malicious activity and remediates customer environment 102 accordingly. After step 722, method 700 ends. It should be noted that the above descriptions encapsulate just one method of using event frequencies to determine priorities for alerts and that other methods are possible and contemplated by embodiments.

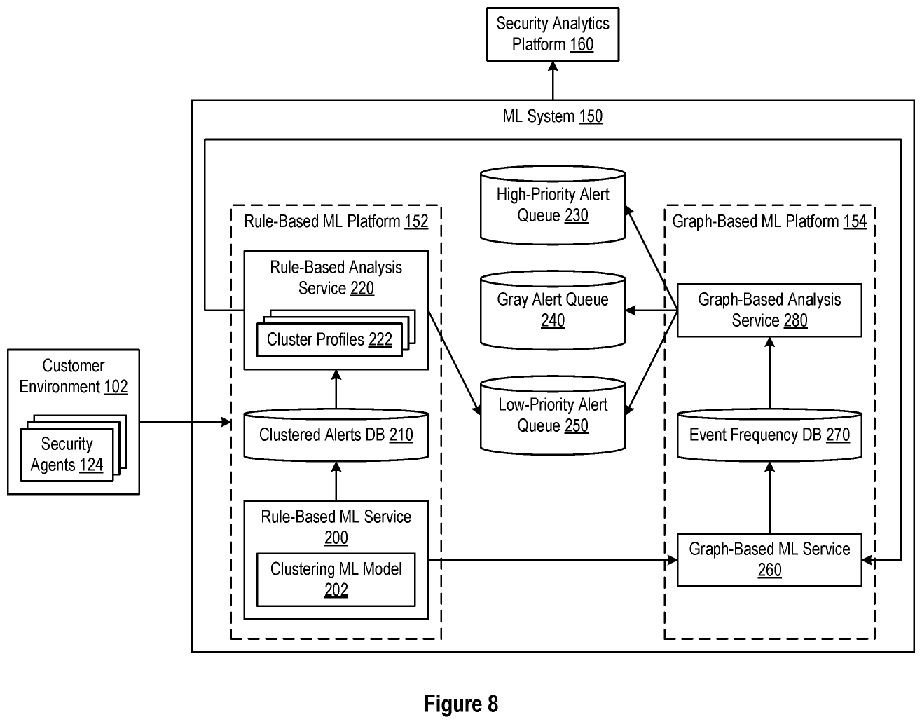

FIG. 8 is a block diagram illustrating components of ML system 150, ML system 150 being configured to perform alternative embodiments. According to the alternative embodiments, during the operational period of ML system 150, rule-based ML platform 152 does not store alerts in high-priority alert queue 230 and gray alert queue 240. Instead, if rule-based analysis service 220 determines that a new alert is high or gray priority, graph-based ML platform 154 analyzes the new alert according to steps 704-722 of FIG. 7. Graph-based analysis service 280 may determine that the new alert is high, gray, or low priority. Graph-based analysis service 280 then stores the new alert in the respective queue, which is high-priority alert queue 230 if the alert is high priority, gray alert queue 240 if gray priority, or low-priority alert queue 250 if low priority.

In some cases, graph-based ML platform 154 determines a more definitive priority level (high or low priority) than rule-based ML platform 152 determines (gray priority). Furthermore, as discussed earlier, for certain types of alerts, graph-based ML platform 154 classifies alerts more accurately than rule-based ML platform 152. If the new alert is malicious, graph-based ML platform 154 may help security analytics platform 160 discover the new alert more quickly by storing the new alert in high-priority alert queue 230 (instead of rule-based ML platform 152 storing it in gray alert queue 240). On the other hand, if the new alert is harmless, graph-based ML platform 154 may prevent security analytics platform 160 from spending valuable time analyzing the harmless alert by storing the new alert in low-priority alert queue 250 (instead of rule-based ML platform 152 storing it in gray alert queue 240).

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer-readable media. The term computer-readable medium refers to any data storage device that can store data that can thereafter be input into a computer system. Computer-readable media may be based on any existing or subsequently developed technology that embodies computer programs in a manner that enables a computer to read the programs. Examples of computer-readable media are magnetic drives, SSDs, network-attached storage (NAS) systems, read-only memory (ROM), RAM, compact disks (CDs), digital versatile disks (DVDs), magnetic tapes, and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host, console, or guest operating system (OS) that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A computer system comprising:
a plurality of endpoints at which security agents generate alerts; and
a machine-learning (ML) system at which alerts are received from the endpoints, wherein the ML system is configured to execute on a processor of a hardware platform to:
upon receiving a first alert and a second alert, apply an ML model to the first and second alerts;
based at least in part on the first alert being determined based on the applied ML model to belong to a first cluster of the ML system, classify the first alert into one of a plurality of alert groups, wherein alerts classified into a first alert group of the alert groups are assigned a higher priority for security risk evaluation than alerts classified into a second alert group of the alert groups; and
based on the second alert being determined based on the applied ML model to not belong to any cluster of the ML system, analyze a chain of events that triggered the second alert to determine whether there is suspicious activity associated with the second alert.

2. The computer system of claim 1, wherein the first cluster has an associated cluster profile that specifies expected value constraints for attributes of alerts that are determined to belong to the first cluster, and wherein the ML system is further configured to:
compare actual values of the attributes for the first alert to the expected value constraints, wherein the classifying of the first alert into the one of the plurality of alert groups is further based on whether there is any deviation between the actual values and the expected value constraints.

3. The computer system of claim 2, wherein based on there being at least one deviation between the actual values and the expected value constraints, the ML system classifies the first alert into the first alert group, and the ML system is further configured to:
transmit the first alert to a security analytics platform for security risk evaluation.

4. The computer system of claim 2, wherein based on there being no deviation between the actual values and the expected value constraints, the ML system classifies the first alert into the second alert group.

5. The computer system of claim 1, wherein an event of the chain of events involves a predetermined suspicious activity, and the ML system is further configured to:
transmit the second alert to a security analytics platform for security risk evaluation.

6. The computer system of claim 1, wherein the ML system is further configured to:
generate a database that stores events detected during a training period of the computer system and that stores frequencies of the events detected during the training period, wherein analyzing the chain of events that triggered the second alert involves retrieving frequencies from the database that correspond to the chain of events and then comparing the retrieved frequencies to a predetermined threshold.

7. The computer system of claim 6, wherein based on one of the retrieved frequencies being less than the predetermined threshold or on a plurality of the retrieved frequencies being collectively less than the predetermined threshold, the ML system determines that suspicious activity is associated with the second alert, and the ML system is further configured to:
transmit the second alert to a security analytics platform for security risk evaluation.

8. The computer system of claim 6, wherein based on each of the retrieved frequencies being greater than the predetermined threshold or on a plurality of the retrieved frequencies being collectively greater than the predetermined threshold, the ML system determines that suspicious activity is not associated with the second alert.

9. The computer system of claim 1, wherein the ML system is further configured to:
build a provenance graph from the chain of events that triggered the second alert, wherein analyzing the chain of events that triggered the second alert involves analyzing causal links in the provenance graph.

10. The computer system of claim 1, wherein the ML system is further configured to:
upon receiving a third alert, apply the ML model to the third alert; and
based at least in part on the third alert being determined based on the applied ML model to belong to a second cluster of the ML system, analyze a chain of events that triggered the third alert to determine whether there is suspicious activity associated with the third alert.

11. A method of processing alerts generated by security agents installed at endpoints of a computer system, the method comprising:
upon receiving a first alert and a second alert, applying an ML model to the first and second alerts;
based at least in part on the first alert being determined based on the applied ML model to belong to a first cluster of the computer system, classifying the first alert into one of a plurality of alert groups, wherein alerts classified into a first alert group of the alert groups are assigned a higher priority for security risk evaluation than alerts classified into a second alert group of the alert groups; and
based on the second alert being determined based on the applied ML model to not belong to any cluster of the computer system:
analyzing a chain of events that triggered the second alert to determine whether there is suspicious activity associated with the second alert, and
classifying the second alert into one of the plurality of alert groups based on whether there is suspicious activity associated with the second alert.

12. The method of claim 11, wherein the first cluster has an associated cluster profile that specifies expected value constraints for attributes of alerts that are determined to belong to the first cluster, and the method further comprises:
comparing actual values of the attributes for the first alert to the expected value constraints, wherein the classifying of the first alert into the one of the plurality of alert groups is further based on whether there is any deviation between the actual values and the expected value constraints.

13. The method of claim 12, wherein based on there being at least one deviation between the actual values and the expected value constraints, the first alert is classified into the first alert group, and the method further comprises:
transmitting the first alert to a security analytics platform for security risk evaluation.

14. The method of claim 12, wherein based on there being no deviation between the actual values and the expected value constraints, the first alert is classified into the second alert group.

15. A non-transitory computer-readable medium comprising instructions that are executable in a computer system, wherein the instructions when executed cause the computer system to carry out a method of processing alerts generated by security agents installed at endpoints of the computer system, and wherein the method comprises:
based on an attribute of alerts received from the endpoints during a training period of the computer system, training an ML model to divide the alerts received during the training period into a plurality of clusters;
after training the ML model, upon receiving a first alert and a second alert, applying the ML model to the first and second alerts;
based at least in part on the first alert being determined based on the applied ML model to belong to a first cluster of the clusters, classifying the first alert into one of a plurality of alert groups, wherein alerts classified into a first alert group of the alert groups are assigned a higher priority for security risk evaluation than alerts classified into a second alert group of the alert groups; and
based on the second alert being determined based on the applied ML model to not belong to any cluster of the clusters, analyzing a chain of events that triggered the second alert to determine whether there is suspicious activity associated with the second alert.

16. The non-transitory computer-readable medium of claim 15, wherein an event of the chain of events involves a predetermined suspicious activity, and the method further comprises:
transmitting the second alert to a security analytics platform for security risk evaluation.

17. The non-transitory computer-readable medium of claim 15, wherein the method further comprises:
generating a database that stores events detected during the training period and that stores frequencies of the events detected during the training period, wherein analyzing the chain of events that triggered the second alert involves retrieving frequencies from the database that correspond to the chain of events and then comparing the retrieved frequencies to a predetermined threshold.

18. The non-transitory computer-readable medium of claim 17, wherein based on one of the retrieved frequencies being less than the predetermined threshold or on a plurality of the retrieved frequencies being collectively less than the predetermined threshold, it is determined that suspicious activity is associated with the second alert, and the method further comprises:
transmitting the second alert to a security analytics platform for security risk evaluation.

19. The non-transitory computer-readable medium of claim 17, wherein based on each of the retrieved frequencies being greater than the predetermined threshold or on a plurality of the retrieved frequencies being collectively greater than the predetermined threshold, it is determined that suspicious activity is not associated with the second alert.

20. The non-transitory computer-readable medium of claim 15, wherein the method further comprises:
building a provenance graph from the chain of events that triggered the second alert, wherein analyzing the chain of events that triggered the second alert involves analyzing causal links in the provenance graph.
